(19) United States
(12) Patent Application Publication
(10) Pub. No.: US 2017/0262596 A1
(43) Pub. Date: Sep. 14, 2017

(54) METHOD AND SYSTEM FOR PREDICTION OF AN OUTCOME OF A STROKE EVENT

(71) Applicant: XEROX CORPORATION, Norwalk, CT (US)

(72) Inventors: Abhishek Sengupta, Kolkata (IN); Vaibhav Rajan, Bangalore (IN); Sakyajit Bhattacharya, Bangalore (IN); Gosala Raja Kukkuta Sarma, Bengaluru (IN)

(21) Appl. No.: 15/063,558

(22) Filed: Mar. 8, 2016

(51) Int. Cl. G06F 19/00; G06N 7/00; G06N 99/00

(52) U.S. Cl. CPC G06F 19/345; G06N 99/005; G06N 7/005

(57) ABSTRACT

A method and a system are provided for prediction of an outcome of a stroke event associated with a first human subject. The method receives a first score, one or more first observations, and one or more second observations associated with the first human subject. The method predicts one or more second scores at the second time instant based on a training of a probabilistic model. The method further selects a second score from the one or more second scores at the second time instant. The second score corresponds to the outcome of the stroke event associated with the first human subject. The second score corresponds to the highest value from the one or more second scores.

### TECHNICAL FIELD

The presently disclosed embodiments are related, in general, to diagnosis of patients suffering from neurovascular diseases. More particularly, the presently disclosed embodiments are related to method and system for prediction of an outcome of a stroke event.

### BACKGROUND

Stroke is the second leading cause of death and a major cause of neurological disability in the world. A stroke happens when blood flow to a part of the brain stops. If blood flow is stopped for longer than a few seconds, the brain cannot get blood and oxygen. Thus, in an embodiment, brain cells die causing permanent damage. Stroke impairs many critical neurological functions, causing large number and broad range of physical and social disabilities. The final outcome of a stroke event may vary considerably from complete recovery to permanent disability and death. Moreover, a treatment that is effective for a first patient may be ineffective or harmful for a second patient.

State of the art technologies utilize a small number of predictive factors to predict the stroke outcome and thus may be unreliable for guiding treatments to the patients. Additionally, utilizing information pertaining to one or more treatments and one or more medications provided to the patient for predicting the outcome of the stroke patient is a challenging task. Further, the treatment must be tailored according to the individual based on identification of the risk of damage and estimation of potential recovery after the stroke event.

Further limitations and disadvantages of conventional and traditional approaches will become apparent to one skill in the art, through comparison of described systems with some aspects of the present disclosure, as set forth in the remainder of the present application and with reference to the drawings.

### SUMMARY

According to embodiments illustrated herein, there may be provided a method implemented in an application server to predict an outcome of a stroke event associated with a first human subject. The method may utilize one or more processors for receiving a first score, one or more first observations, and one or more second observations associated with the first human subject. In an embodiment, the first score and the one or more first observations may be determined at a first time instant of admittance of the first human subject into a medical facility. In an embodiment, the one or more second observations may be received from one or more sensors during a time interval between the first time instant and a second time instant. The method may predict one or more second scores at the second time instant based on a training of a probabilistic model. The method may further select a second score from the one or more second scores at the second time instant. In an embodiment, the second score corresponds to the outcome of the stroke event associated with the first human subject. In an embodiment, the second score corresponds to the highest value from the one or more second scores.

According to embodiments illustrated herein, there may be provided an application server that may comprise of one or more processors configured to predict an outcome of a stroke event associated with a first human subject. The one or more processors may be configured to receive a first score, one or more first observations, and one or more second observations associated with the first human subject. In an embodiment, the first score and the one or more first observations may be determined at a first time instant of admittance of the first human subject into a medical facility. In an embodiment, the one or more second observations are received from one or more sensors during a time interval between the first time instant and a second time instant. The one or more processors may be configured to predict one or more second scores at the second time instant based on a training of a probabilistic model. The one or more processors may be further configured to select a second score from the one or more second scores at the second time instant, wherein the second score corresponds to the outcome of the stroke event associated with the first human subject. In an embodiment, the second score corresponds to the highest value from the one or more second scores.

According to embodiments illustrated herein, a non-transitory computer-readable storage medium having stored thereon, a set of computer-executable instructions for causing a computer comprising one or more processors to perform steps of receiving a first score, one or more first observations, and one or more second observations associated with a first human subject. In an embodiment, the first score and the one or more first observations may be determined at a first time instant of admittance of the first human subject into a medical facility. In an embodiment, the one or more second observations may be received from one or more sensors during a time interval between the first time instant and a second time instant. The one or more processors may be configured to predict one or more second scores at the second time instant based on a training of a probabilistic model. The one or more processors may be further configured to select a second score from the one or more second scores at the second time instant, wherein the second score corresponds to the outcome of the stroke event associated with the first human subject. In an embodiment, the second score corresponds to the highest value from the one or more second scores.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram that illustrates a system environment in which various embodiments of the method and the system may be implemented;

FIG. 2 is a block diagram that illustrates an application server 104 configured to predict an outcome of the stroke event associated with the first human subject, in accordance with at least one embodiment;

FIG. 3 illustrates a flowchart of a method to create and train a probabilistic model, in accordance with at least one embodiment;

FIG. 4 illustrates a flowchart of a method to utilize the trained probabilistic model to predict an outcome of a stroke event, in accordance with at least one embodiment; and

FIG. 5 illustrates an example user-interface presented on a user-computing device to display the predicted outcome of the stroke event.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Definitions: The following terms shall have, for the purposes of this application, the respective meanings set forth below.

A “stroke event” also known as cerebrovascular accident (CVA), cerebrovascular insult (CVI), or brain attack, is when poor blood flow to the brain results in cell death. There are two main types of stroke: ischemic, due to lack of blood flow, and hemorrhagic, due to bleeding. They result in part of the brain not functioning properly. Signs and symptoms of a stroke may include an inability to move or feel on one side of the body, problems understanding or speaking, feeling like the world is spinning, or loss of vision to one side among others. The signs and symptoms often appear soon after the stroke has occurred. If the symptoms last less than one or two hours it is known as a transient ischemic attack.

A “patient dataset” corresponds to historical data pertaining to one or more human subjects previously examined by a medical practitioner. In an embodiment, the patient dataset includes information pertaining to measured one or more physiological parameters. In an embodiment, the patient dataset comprises of a first score, a second score, one or more first observations, and one or more second observations. In an embodiment, the patient dataset is utilizable as a training dataset to train a probabilistic model.

A “human subject” corresponds to a human being, who may be suffering from a health condition or a disease. In an embodiment, the human subject may correspond to a person who seeks a medical opinion on his/her health condition. In an embodiment, a first human subject refers to the human subject for which a second score is to be predicted. In an embodiment, a second human subject refers to the human subject whose patient dataset (first score, second score, one or more first observations, and one or more second observations) may be utilized to predict the second score associated with the first human subject.

A “probabilistic model” corresponds to a model that determines a probability of a second score of a first human subject based on a first score, one or more first observations and one or more second observations received from a user-computing device. The probabilistic model shall be broadly construed, to include any calculation of probability; approximation of probability, using any type of input data, regardless of precision or lack of precision; any number, either calculated or predetermined, that simulates a probability; or any method step having an effect of using or finding some data having some relation to a probability.

A “first score” refers to a value that is indicative of the condition of a human subject at a first time instant of admittance of the human subject into a medical facility. In an embodiment, the first score corresponds to a Rankin score.

A “second score” refers to a value that is indicative of the condition of a human subject at a second time instant. In an embodiment, the second time instant corresponds to at least the time instant at which the human subject is discharged from a medical facility. In an alternate embodiment, the second time instant corresponds to the time instant after a time interval during which one or more treatments are utilized to treat the human subject. In an embodiment, the second score corresponds to a Rankin score. In an embodiment, the second score corresponds to an outcome of a stroke event associated with a human subject. In an embodiment, the table 1 given below shows the Rankin score associated with the human subject and the health condition of the human subject, after/before a stroke event, corresponding to the Rankin score.

TABLE 1
Rankin Score

| Rankin | |
|---|---|
| score | Health condition of the human subject |
| 1 | No symptoms at all |
| 2 | No significant disability despite symptoms; able to carry out |
| | usual duties and activities |
| 3 | Slight disability; unable to carry out all previous activities, but |
| | able to look after own affairs without assistance |
| 4 | Moderate disability; requiring some help, but able to walk |
| | without assistance |
| 5 | Moderately severe disability; unable to walk without assistance |
| | and unable to attend to bodily needs without assistance |
| 6 | Severe disability; bedridden, incontinent and requiring constant |
| | nursing care and attention |
| 7 | Dead |

“One or more first observations” refer to non-clinical features associated with a human subject. In an embodiment, the one or more first observations associated with the human subject may have an associated data type. Examples of the data type may include, but are not limited to, a binary data type (e.g., gender, parameters related to past addictions, past diseases, past medications, and the like.), a categorical data type (e.g., education level, job type, and the like), and a numerical data type (e.g., age). Examples, of the one or more first observations comprise at least an age, a gender, and one or more preconditions.

“One or more second observations” refer to clinical features associated with a human subject. In an embodiment, the one or more second observations associated with the human subject may have an associated data type. Examples of the data type may include, but are not limited to, a categorical data type (e.g., parameters related to radiological results, and the like), and a numerical data type (e.g., parameters related to blood investigation results). Examples, of the one or more second observations comprises at least a radiology investigation, treatment details, clinical investigations (radiology/lab investigations—blood tests, urine tests, biomarkers, imaging tests like MRI, CT, ECHO, Doppler), physical examination results like neurological deficits, and the like.

A “sensor” refers to a device that detects/measures events or changes in quantities and provides a corresponding output, generally as an electrical or optical signal. In medical science, the sensor may be operable to detect biological, physical, and/or chemical signals associated with a human subject and may measure and record those signals. For example, pressure sensors, temperature sensors, and humidity sensors are used to monitor and regulate gas flow and gas conditions in Anesthesia Machines, Respirators and Ventilators. In an embodiment, such sensors are utilized to determine one or more second observations associated with the human subject.

“Training” refers to imparting knowledge or skills pertaining to a particular domain of study such as, but not limited to, science, mathematics, art, literature, language, philosophy, and so on. In an embodiment, training refers to training of a probabilistic model based on a patient dataset. In an embodiment, based on the training an outcome of a stroke event associated with a human subject may be predicted.

A “first time instant” refers to a time stamp at which a human subject is admitted to a medical facility. In an embodiment, at the first time instant a first score and one or more first observations associated with the human subject are determined.

A “second time instant” refers to a time stamp at which a second score associated with a human subject is predicted. Further, in an embodiment, at the second time instant, one or more second observations associated with the human subject may be determined and transmitted to an application server for prediction of the second score. In an embodiment, the second time instant corresponds to at least the time instant at which the human subject is discharged from the medical facility. In an alternate embodiment, the second time instant corresponds to the time instant after a time interval during which one or more treatments are utilized to treat the human subject.

A “time interval” refers to a time duration between a first time instant and a second time instant during which one or more treatments are utilized to treat the human subject.

A “data structure” refers to a grouping of data that is represented in a particular format for storage or further processing. In an embodiment, the data structure may store a statistical model. In an embodiment, the data structure may correspond to a k1×k2 dimensional data structure. In an embodiment, each entry in the data structure corresponds to a number of human subjects having a first score k1 and a second score k2. In an embodiment, the k1×k2 dimensional data structure may be referred to as a contingency matrix. In an embodiment, the contingency matrix is utilized to represent data in a patient dataset. Examples of the data structure include, but are not limited to, a Bloom filter, a Tries, or a BK tree.

A “difference” refers to value obtained by performing a subtraction operation between a first score and a second score associated with a human subject. In an embodiment, the difference is indicative of an improvement or deterioration in the human subject's condition. In an embodiment, a positive value of the difference indicates improvement in the human subject's condition, and a negative value of the difference indicates deterioration in the human subject's condition.

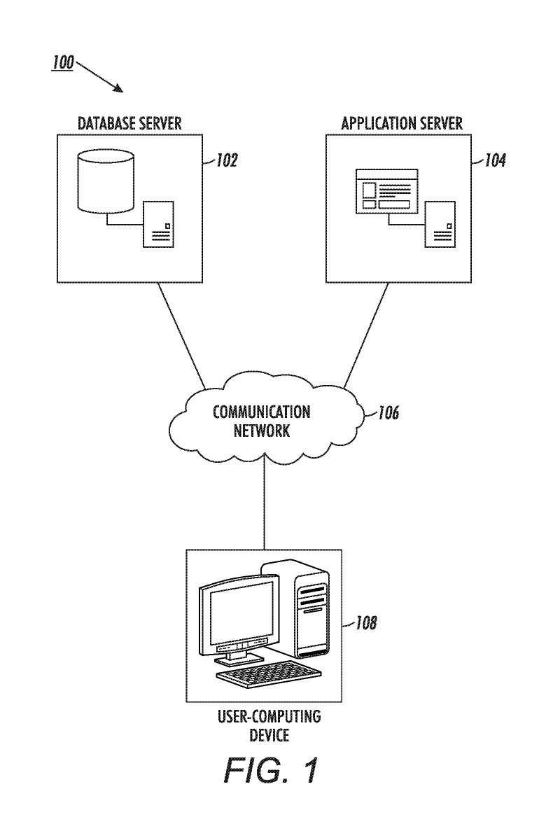

FIG. 1 is a block diagram that illustrates a system environment 100 in which various embodiments of the method and the system may be implemented. The system environment 100 includes a database server 102, an application server 104, a communication network 106, and a user-computing device 108. The database server 102, the application server 104, and the user-computing device 108 may be communicatively coupled to each other via communication network 106. In an embodiment, the application server 104 communicates with the database server 102 and the application server 104 using one or more protocols such as, but not limited to, Open Database Connectivity (ODBC) protocol and Java Database Connectivity (JDBC) protocol.

In an embodiment, the database server 102 may refer to a computing device that may be configured to store a patient dataset comprising a first score, a second score, one or more first observations, and one or more second observations based on data received via one or more sensors associated with the user-computing device 108. In an embodiment, the database server 102 may be further configured to store the patient dataset in an indexed format. The database server 102 may be further configured to receive a query from the application server 104 that may include a request to transmit the patient dataset pertaining to a plurality of second human subjects to the application server 104. In an embodiment, the database server 102 may be configured to receive updated patient dataset (after imputation of missing values) from the application server 104. In an embodiment, the database server 102 may include a special purpose operating system specifically configured to perform one or more database operations on the patient dataset. Examples of the one or more database operations may include, but are not limited to, Select, Insert, Update, and Delete. In an embodiment, the database server 102 may include hardware and/or software that may be configured to perform the one or more database operations. In an embodiment, the database server 102 may be realized through various technologies such as, but not limited to, Microsoft® SQL Server, Oracle®, IBM DB2®, Microsoft Access®, PostgreSQL®, MySQL® and SQLite®, and the like.

A person with ordinary skills in the art will understand that the scope of the disclosure is not limited to the database server 102 as a separate entity. In an embodiment, the functionalities of the database server 102 may be integrated into the application server 104 or vice-versa.

In an embodiment, the application server 104 refers to a computing device or a software framework hosting an application or a software service. In an embodiment, the application server 104 may be implemented to execute procedures such as, but not limited to, programs, routines, or scripts stored in one or more memories for supporting the hosted application or the software service. In an embodiment, the hosted application or the software service may be configured to perform one or more predetermined operations. In an embodiment, the one or more predetermined operations may comprise at least predicting one or more second scores at a second time instant based on a training of a probabilistic model. In an embodiment, the probabilistic model may be created by the application server 104 based on the received patient dataset (training data). In an embodiment, the application server 104 may be implemented in the form of a software installed within the user-computing device 108. In an embodiment, the application server 104 may be realized through various types of application servers such as, but not limited to, a Java application server, a .NET framework application server, a Base4 application server, a PHP framework application server, or any other application server framework.

The application server 104 may be configured to transmit a query that includes a request to receive the patient dataset pertaining to the plurality of second human subjects from the database server 102. In response to the transmitted query, the application server 104 may be configured to receive the patient dataset pertaining to the plurality of second human subjects. In an embodiment, the application server 104 may be configured to impute missing values in the one or more second observations associated with the plurality of second human subjects. Based on the received patient dataset (training data), the application server 104 may be configured to create a k1×k2 dimensional data structure. Further, the application server 104 may be configured to train the probabilistic model based on the received patient dataset. In an implementation scenario, the application server 104 may be configured to receive the first score, the one or more first observations, and the one or more second observations associated with a first human subject. In an embodiment, application server 104 may be configured to utilize the trained probabilistic model for prediction of an outcome of a stroke event associated with the first human subject. In an embodiment, the application server 104 may be configured to select a second score from one or more second scores after a time interval at a second time instant.

In an embodiment, the communication network 106 corresponds to a communication medium through which the database server 102, the application server 104, and the user-computing device 108, may communicate with each other. Such a communication may be performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 104 includes, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

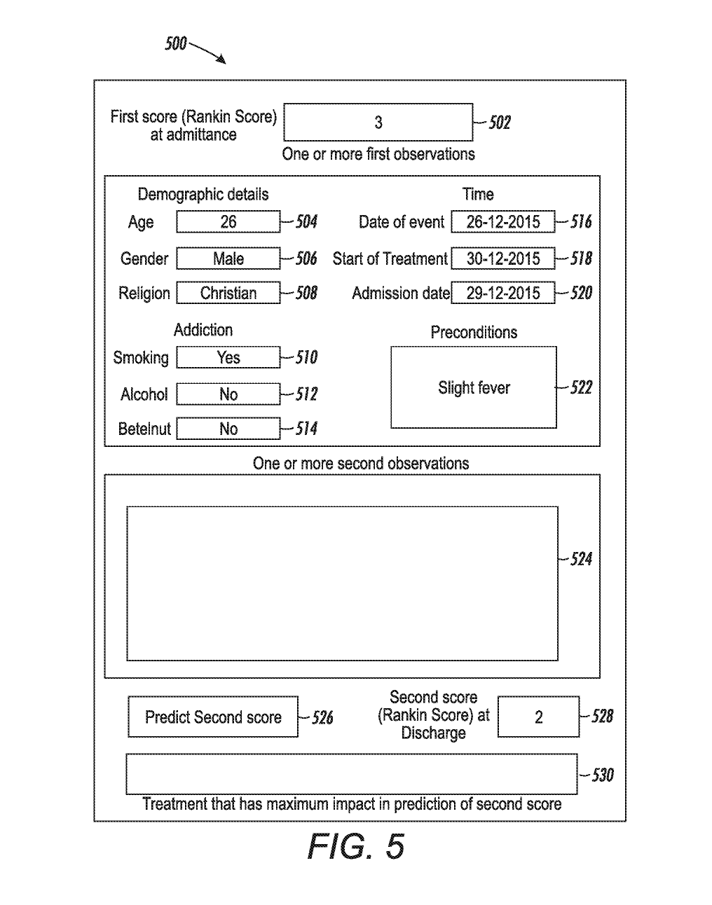

In an embodiment, the user-computing device 108 refers to a computing device used by a user. In an embodiment, the user may correspond to a medical practitioner or a nurse who may utilize the user-computing device 108 to input the first score, the one or more first observations and the one or more second observations associated with the first human subject. The user-computing device 108 comprises one or more processors and one or more memories. The one or more memories may include computer readable code that is executable by the one or more processors to perform predetermined operations. In an embodiment, the user-computing device 108 may present a user-interface to the user to display the predicted outcome (second score) of the stroke event associated with the first human subject. In an embodiment, the user-computing device 108 may include hardware (one or more sensors) and software to transmit the generated patient dataset to the database server 102 and/or the application server 104. Example user-interface presented on the user-computing device 108 for presenting the predicted outcome (second score) of the stroke event associated with the first human subject has been explained in conjunction with FIG. 5. Examples of the user-computing device 108 may include, but are not limited to, a personal computer, a laptop, a personal digital assistant (PDA), a mobile device, a tablet, or any other computing device.

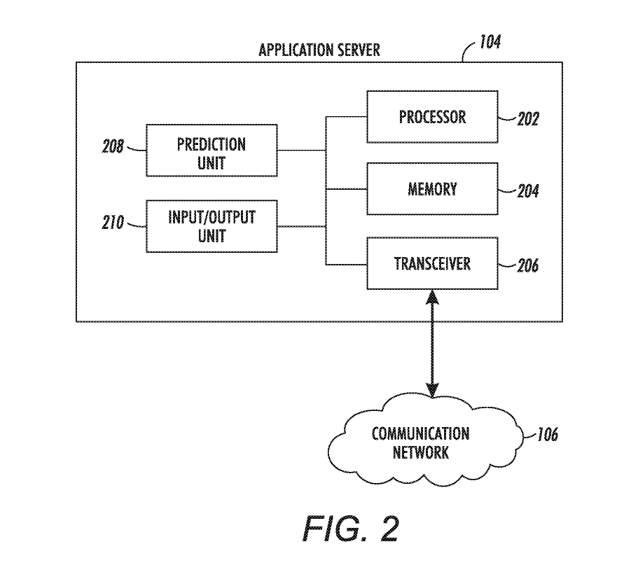

FIG. 2 is a block diagram that illustrates the application server 104 configured to predict the outcome of the stroke event associated with the first human subject, in accordance with at least one embodiment. FIG. 2 is explained in conjunction with elements from FIG. 1. In an embodiment, the application server 104 includes a processor 202, a memory 204, a transceiver 206, a prediction unit 208, and an input/output unit 210. The processor 202 may be communicatively connected to the memory 204, the transceiver 206, the prediction unit 208, and the input/output unit 210. The transceiver 206 may be communicatively coupled to the communication network 104.

The processor 202 comprises suitable logic, circuitry, interfaces, and/or code that may be configured to execute a set of instructions stored in the memory 204. The processor 202 may be implemented based on a number of processor technologies known in the art. The processor 202 works in conjunction with the prediction unit 208 to predict the outcome (second score) of the stroke event associated with the first human subject. Examples of the processor 202 include, but are not limited to, an X86-based processor, a Reduced Instruction Set Computing (RISC) processor, an Application Specific Integrated Circuit (ASIC) processor, a Complex Instruction Set Computing (CISC) processor, and/or other processors.

The memory 204 comprises suitable logic, circuitry, interfaces, and/or code that may be configured to store the set of instructions, which are executed by the processor 202. In an embodiment, the memory 204 may be configured to store one or more programs, routines, or scripts that are executed by the processor 202 in conjunction with the prediction unit 208. In an embodiment, the probabilistic model may be stored in the memory 204. The memory 204 may be implemented based on a Random Access Memory (RAM), a Read-Only Memory (ROM), a Hard Disk Drive (HDD), a storage server, and/or a Secure Digital (SD) card.

The transceiver 206 comprises suitable logic, circuitry, interfaces, and/or code that may be configured to transmit a query that includes a request to receive the patient dataset pertaining to the plurality of second human subjects from the database server 102. In an embodiment, the transceiver 206 may be configured to receive the patient dataset pertaining to the plurality of second human subjects in response to the transmitted query, via the communication network 104. In an implementation scenario, the transceiver may be configured to receive the first score, the one or more first observations, and the one or more second observations associated with the first human subject. The transceiver 206 implements one or more known technologies to support wired or wireless communication with the communication network 106. In an embodiment, the transceiver 206 includes, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 communicates via wireless communication with networks, such as the Internet, an Intranet and/or a wireless network, such as a cellular telephone network, a wireless local area network (LAN) and/or a metropolitan area network (MAN). The wireless communication uses any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The prediction unit 208 comprises suitable logic, circuitry, interfaces, and/or code that may be configured to impute missing values in the one or more second observations associated with the first human subject and the plurality of second human subjects. Further, the prediction unit 208 may be configured to create a contingency matrix based on the training data. The prediction unit 208 may be configured to create the probabilistic model based on the received patient dataset. Further, in an embodiment, the prediction unit 208 may be configured to train the probabilistic model based on the received the patient dataset. In an implementation scenario, the prediction unit 208 may be configured to utilize the trained probabilistic model for prediction of the one or more second scores at the second time instant based on the training of the probabilistic model. In another embodiment, the prediction unit 208 may be implemented as an Application-Specific Integrated Circuit (ASIC) microchip designed for a special application, such as to select the second score from the one or more second scores at the second time instant. In an embodiment, the second score may correspond to the outcome of the stroke event associated with the first human subject. In an embodiment, the second score may correspond to the highest value from the one or more second scores.

The input/output unit 210 comprises suitable logic, circuitry, interfaces, and/or code that may be configured to receive an input or provide an output to a user. The input/output unit 210 comprises various input and output devices that are configured to communicate with the processor 202. Examples of the input devices include, but are not limited to, a keyboard, a mouse, a joystick, a touch screen, a microphone, a camera, and/or a docking station. Examples of the output devices include, but are not limited to, a display screen and/or a speaker.

In operation, the database server 102 may be configured to generate the patient dataset based on the first score, the one or more first observations and the one or more second observations received from the user-computing device 108 via the communication network 106. In an embodiment, the one or more second observations may be obtained from the one or more sensors associated with the user-computing device 108. In an embodiment, the first score may correspond to a value that is indicative of the condition of the plurality of second human subjects at a first time instant of admittance of the plurality of second human subjects into a medical facility. In an embodiment, the first score corresponds to a Rankin score. The Table 2 illustrates an exemplary scenario of the first score associated with the plurality of second human subjects in the generated patient dataset.

TABLE 2
First score associated with the plurality of second human subjects

| Second Human Subject ID | First score (Rankin score) |
|---|---|
| Second Human Subject 1 | 3 |
| Second Human Subject 2 | 2 |
| Second Human Subject 3 | 4 |
| Second Human Subject 4 | 5 |
| Second Human Subject 5 | 5 |
| Second Human Subject 6 | 6 |
| Second Human Subject 7 | 7 |
| Second Human Subject 8 | 3 |
| Second Human Subject 9 | 2 |
| Second Human Subject 10 | 4 |

In an embodiment, the one or more first observations may refer to non-clinical features associated with the plurality of second human subjects. In an embodiment, the one or more first observations associated with the plurality of second human subjects may have an associated data type. Examples of the data type may include, but are not limited to, a binary data type (e.g., gender, parameters related to past addictions, past diseases, past medications, and the like.), a categorical data type (e.g., education level, job type, and the like), and a numerical data type (e.g., age). Examples, of the one or more first observations comprise at least an age, a gender, and one or more preconditions. The Table 3 illustrates the one or more first observations associated with the plurality of second human subjects.

TABLE 3
One or more first observations associated with the plurality of second
human subjects

| | One or more first observations | | | |
|---|---|---|---|---|
| Second Human Subject ID | Age | Gender | Job Type | Preconditions |
| Second Human Subject 1 | 35 | Male | Private Service | Slight fever |
| Second Human Subject 2 | 40 | Female | Private Service | NA |
| Second Human Subject 3 | 23 | Male | Business | Alcoholic |
| Second Human Subject 4 | 56 | Female | Government | NA |
| Second Human Subject 5 | 26 | Male | Private Service | Hyperthyroidism |
| Second Human Subject 6 | 39 | Male | Government | Alcoholic |
| Second Human Subject 7 | 68 | Male | Business | NA |
| Second Human Subject 8 | 54 | Male | Private Service | Smoking addiction |
| Second Human Subject 9 | 45 | Female | Private Service | NA |
| Second Human Subject 10 | 26 | Male | Government | Hypothyroidism |

In an embodiment, the one or more second observations may refer to clinical features associated with the plurality of second human subjects. In an embodiment, the one or more second observations associated with the plurality of second human subjects may have an associated data type. Examples of the data type may include, but are not limited to, a categorical data type (e.g., parameters related to radiological results, and the like), and a numerical data type (e.g., parameters related to blood investigation results). Examples, of the one or more second observations comprises at least a radiology investigation, treatment details, clinical investigations (radiology/lab investigations—blood tests, urine tests, biomarkers, imaging tests like MRI, CT, ECHO, Doppler), physical examination results like neurological deficits, and the like. The Table 4 illustrates the one or more second observations associated with the plurality of second human subjects.

TABLE 4
One or more second observations associated with the plurality of second
human subjects

| Second | | | | | |
|---|---|---|---|---|---|
| Human | One or more second observations | | | | |
| Subject | Blood | Neurological | Other | Radiology | |
| ID | investigations | deficits | investigations | tests | Treatment |
| Second | Hb = 18.1 g/dl | NA | Abdominal Scan: | Echo | Aspirin |
| Human | Platelet = 3 | | Significant Post | | Clopidogrel |
| Subject 1 | lakh/ul | | Void Residue of | | Atorvastatin |
| | Albumin = 2.9 g/dl | | 47 ml | | |
| | Serum Na = | | | | |
| | 137 mEq/l | | | | |
| Second | TC = 20.8/ul | Hemianoptia | NA | Doppler | Aspirin |
| Human | Neutrophils = | | | | Rosuvastatin |
| Subject 2 | 68% | | | | Aravon |
| | ESR = NA | | | | Strocit |
| | Cholesterol = | | | | |
| | 202 mg/dl | | | | |
| Second | HDL = 35 mg/dl | NA | NA | NA | Clopidogrel |
| Human | LDL = 86 mg/dl | | | | Heparin |
| Subject 3 | | | | | Fragmin |
| Second | Albumin = 2.9 g/dl | NA | USG abdomen: | MRI | Acitrom |
| Human | Serum Na = | | Bilateral Grade 1 | | t-PA |
| Subject 4 | 145 mEq/l | | Renal | | Anti-HTN Drugs |
| | FBS/RBS = | | Parenchymal | | |
| | 180/103 | | Changes | | |
| Second | Triglycerides = | Ophthalmo- | NA | NA | Aspirin |
| Human | 233 mg/dl | paresis | | | Clexane |
| Subject 5 | Homocysteine = | | | | |
| | 51.8 | | | | |
| Second | B12 = 142 | Dysarthria | NA | CT | Warfarin |
| Human | HB = 15.7 g/dl | | | | Acitrom |
| Subject 6 | TC = 12070/ul | | | | t-PA |
| Second | Platelet = 4.16 | Aphasia | NA | NA | Clopidogrel |
| Human | lakh/ul | | | | Atorvastatin |
| Subject 7 | Creatinine = | | | | Aravon |
| | 1.3 mg/dl | | | | |
| Second | FBS = 103 | NA | Renal scan: | NA | Strocit |
| Human | TSH = NA | | Bilateral grade 1 | | Heparin |
| Subject 8 | | | renal | | Fragmin |
| | | | parenchymal | | |
| | | | changes | | |
| Second | HB = 9.8 g/dl | Apraxia | NA | MRI | Aspirin |
| Human | TC = 6570/ul | | | | Clopidogrel |
| Subject 9 | | | | | Aravon |
| Second | ESR = 44 mm/hr | NA | Abdominal Scan: | NA | Clexane |
| Human | Creatinine = 1 mg/dl | | Fatty Liver, Mild | | Aravon |
| Subject | | | Prostatomegaly | | t-PA |
| 10 | | | | | |

In an embodiment, the patient dataset (training data) may also include the second score associated with each of the plurality of second human subjects. The training data may be used such that the second score of second human subject may be predicted using the method described herein and then the predicted score may be compared with the actual score of the second human subject available in the patient dataset. After generation of the patient dataset (training data) at the database server 102, the processor 202 may be configured to receive the patient dataset (training data) of the plurality of second human subjects at the application server 104. In an embodiment, the patient dataset may be utilized to train the probabilistic model after imputing the missing values in the one or more second observations. In an embodiment, the one or more second observations may contain missing values as all measurements/investigations may not be performed for each of the plurality of second human subjects. In an embodiment, both continuous and categorical data may be present in the one or more second observations.

In an embodiment, known in the art techniques for imputation, such as MICE (multiple imputation methods) may be utilized to impute missing values associated with the blood investigations, the neurological deficits, the other investigations, and the radiology tests. In an embodiment, multiple imputation produces continuous imputed values, as the underlying model is assumed to be continuous. In an embodiment, in order to predict the missing values, the continuous predicted value is rounded off to the nearest integer to give a discrete value. In an embodiment, such rounding off may be based on an arbitrary cut off which heavily biases the estimates. For example, for binary data if the cut off value is selected as 0.5 then the imputed value will be unbiased if and only if the underlying distribution is a symmetric distribution centered around 0.5. For example, missing values associated with the blood investigation TSH of the “Second Human Subject 8” may be determined in accordance with the known in the art imputation techniques. However, the missing values associated with the one or more treatments given to each of the plurality of second human subjects may be determined as described below. Further, the missing values associated with the one or more treatments are categorical (discrete) in nature. For example, dosage of Fragmin: =0 denotes no dosage; 1 denotes mild dosage, and 2 denotes heavy dosage.

Given a set of observations labelled 1, 2, . . . , N; for the ith observation, let (xi, yi) be the features with yi denoting a response variable. In an embodiment, the response variable may correspond to the variable for which the missing value is to be imputed. Let xᵢε [symbol] ^{p} be the vectors of predictors. In accordance with MICE, the value of yi must be from Y₋ᵢ={y₁, . . . , yᵢ₋₁, yᵢ₊₁, . . . , y_{N},}. In an embodiment, the subset of Y₋ᵢ may contain only the non-missing values. In order to determine the missing values, the application server 104 may be configured to define a measure of association Q_{K} for each observation k with yₖ missing value. In an embodiment, the measure of association Q_{K} may be determined in accordance with equation 1.

$$Measure of association = {Q}_{K} = \frac{{C}_{k} - {D}_{k}}{{C}_{k} + {D}_{k}} \qquad ( 1 )$$

where

Cₖ=Σᵢ₌₁^{p}I (x_{k,j}=x_{i,j}); and

Dₖ=Σᵢ₌₁^{p}I (x_{k,j}≠x_{i,j}); the sum being over j for which x_{k,j} and x_{i,j} are non-missing.

Thus, Cₖ and Dₖ denote the number of concordant and discordant pairs, respectively, between the ith and the kth observation. In an embodiment, Q_{K} is similar to Kendall's measure of association. In an embodiment, a higher value of Q_{K} indicates a stronger association. In an embodiment, under the null hypothesis of no association, Q_{K} will be zero. In an embodiment, the strength of association of Q_{K} may be tested asymptotically using the asymptotic distribution of Q_{K} as shown in equation 2.

$$\frac{{Q}_{K}}{\sqrt{Var ( {Q}_{K} )}} ∼ {H}_{0} N ( 0 , 1 ) \qquad ( 2 )$$

In an embodiment, the application server 104 may be configured to select ‘m’ highest values of Q_{K}. In an embodiment, the value of ‘m’ maybe obtained from the user. In an embodiment, the application server 104 may be configured to select a value at random from them, and take the yk value corresponding to the observation as the imputed value.

For example, in the following table:

TABLE 5

| Qₖ Values | Observations | | | | | | |
|---|---|---|---|---|---|---|---|
| (2 − 3)/(2 + 3) | 1 | 1 | NA | 0 | 1 | 1 | 0 |
| — | NA | 0 | 3 | 1 | 2 | 1 | 0 |
| (3 − 3)/(3 + 3) | 0 | 0 | 1 | 1 | 3 | 0 | 0 |

In an embodiment, if we want to impute the observation in the second row, first column, it is most likely to be imputed by the value 0 in the third row, first column as the Qₖ value of the third row is higher.

In an embodiment, after imputation of the missing values based on the measure of association, the application server 104 may be configured to update the patient dataset. In an embodiment, the patient dataset (training data) may be represented using a k1×k2 dimensional data structure. Based on the generated training data, the prediction unit 108 may be configured to create the k1×k2 dimensional data structure where each entry in the data structure corresponds to a number of the plurality of second human subjects having a first score k1 and a second score k2. In an embodiment, the data structure may correspond to a k1×k2 contingency matrix, which is indicative of the first score and the second score of the plurality of second human subjects based on the patient dataset (training data). In an embodiment, the k1×k2 contingency matrix is indicative of the first score and the second score of the plurality of second human subjects, where each entry in the contingency matrix corresponds to a number of stroke patients from the plurality of second human subjects having a first score k1 and a second score k2.

For the Rankin score on a scale of 1 to K, the K×K contingency matrix may be represented as below:

$$[ \begin{matrix}{n}_{1 , 1} & ⋯ & {n}_{1 , j} & ⋯ & {n}_{1 , K} \\ ⋯ & ⋯ & ⋯ & ⋯ & ⋯ \\ {n}_{i , 1} & ⋯ & {n}_{i , j} & ⋯ & {n}_{i , K} \\ ⋯ & ⋯ & ⋯ & ⋯ & ⋯ \\ {n}_{K , 1} & ⋯ & {n}_{K , j} & ⋯ & {n}_{K , K}\end{matrix} ]$$

where

n_{i,j} denotes the number of patients having admission score (first score) I; and

discharge score (second score) j.

For example, for a patient dataset of 211 patients, the contingency matrix that represents the number of patients having admission score (first score) i and discharge score (second score) j may be represented as below.

$$[ \begin{matrix}19 & 0 & 0 & 0 & 0 \\ 22 & 30 & 1 & 0 & 0 \\ 1 & 24 & 23 & 0 & 2 \\ 0 & 0 & 29 & 27 & 2 \\ 0 & 0 & 2 & 11 & 18\end{matrix} ]$$

In an embodiment, the value ‘19’ in the first column and first row denotes that the first score and the second score of 19 patients is 1. Further, the value ‘22’ in the first column and second row denotes that 22 patients had a first score 2 and a second score of 1. Similarly, the value ‘1’ in the first column and third row denotes that one patient had a first score of 3 and a second score of 1. The other values in the contingency matrix may be interpreted accordingly.

In an embodiment, based on the generated patient dataset represented using the contingency matrix, the prediction unit 208 may be configured to create a probabilistic model predicting one or more second scores. In an embodiment, the probabilistic model may be represented in accordance with the equation 3 as shown below. In an embodiment, the likelihood may be modelled as a multinomial probability, where the normalization constants may be ignored since they are independent of the unknown parameters.

$$\begin{matrix} L ( θ ) α {\prod }_{i = 1}^{K} {\prod }_{j = 1}^{K} {\prod }_{k = 1}^{N} {p ( i \to j \vert {x}_{k} , {y}_{k} )}^{{r}_{k , i} {c}_{k , j}} & ( 3 ) \\ where & \\ {r}_{k , i} = \{ \begin{matrix}1 , & if the kth observation has a first score of i ( ith row ) ; \\ 0 , & otherwise\end{matrix} \\ {c}_{k , j} = \{ \begin{matrix}1 , & if the kth observation has a second score of j ( jth row ) ; \\ 0 , & otherwise .\end{matrix} & \end{matrix}$$

and

p(i→j|xₖ, yₖ) is the probability of a patient having first score i, to have a second score j; given (xₖ, yₖ) where xₖ corresponds to the one or more first observations, and yₖ corresponds to the one or more second observations.

In an embodiment, the probability of a patient having first score i, to have a second score j is given in accordance with equation 4.

$$p ( i \to j \vert {x}_{k} , {y}_{k} ) = \frac{{λ}_{i} ( {x}_{k} )}{α + {λ}_{i} ( {x}_{k} ) + {K}_{ij} γ ( {y}_{k} )} \qquad ( 4 )$$

where

λᵢ(xₖ)=exp(β₀ᵢ+Σₗ₌₁^{L}βₗᵢxₖₗ), denotes the row effect of the ith row;

γ(yₖ)=exp(δ₀ⱼ−Σₘ₌₁^{M}δₘⱼyₖₘ), denotes the column effect of the jth column;

Kᵢⱼ=C {(j−i)²+1}, C is a constant; and

α=0.001 is a chosen constant close to zero.

In an embodiment, the coefficients corresponding to the one or more treatments associated with the each of the plurality of second human subjects may be utilized to learn the coefficients associated with the first human subject. A person skilled in the art will understand that during the training of the probabilistic model, the coefficients associated with the first human subject may also be learnt. In an embodiment, the values on the rows of the contingency matrix may represent the row effects denoted by λᵢ(xₖ) and may depend only on the observations made prior to admission (one or more first observations). In an embodiment, the values on the columns of the contingency matrix may represent the column effects denoted by γ(yₖ) depend only on the observations made during the patients stay at the hospital (one or more second observations). In an embodiment, the Kᵢⱼ term is introduced in equation 4 which increases the probability value if i is close to j. Further, constant α is introduced in the denominator for handling model identify ability problems. In an embodiment, if the term α is not present then multiplying the numerator and the denominator by a constant will not affect the probability but will change the values of the coefficient estimates, making it necessary to the impose constraints on the parameters.

In an embodiment, values corresponding to the one or more second observations that are utilized for the one or more treatments appear only in the denominator. Thus, for a human subject whose health condition has improved, the coefficients corresponding to the one or more treatments that have the least values will have maximum impact in the improvement. In an embodiment, since the probabilistic model is purely probabilistic, the distributions of the coefficients may be derived directly or asymptotically and hence p-values may be computed to statistically select the one or more treatments that were significant in improving the health condition of the second human subject.

In an embodiment, the probabilistic model may be trained based on the generated patient dataset of 211 patients that is represented as the contingency matrix as shown above. In an embodiment, maximum number of the plurality of human subjects are present along the diagonal of the contingency matrix. This is indicative that most patients with a first score i have a second score i. In an implementation scenario, the probabilistic model may be trained based on the training data using known in the art training techniques. After the training of the probabilistic model by the prediction unit 208, the application server 104 may be configured to receive the first score, the one or more first observations, and the one or more second observations associated with the first human subject from the user-computing device 108. In an embodiment, the first score and the one or more first observations are determined at the first time instant of admittance of the first human subject into a medical facility, and the one or more second observations are received from one or more sensors during a time interval between the first time instant and a second time instant. Further, the application server 104 may be configured to receive a request for estimation of the second score associated with the first human subject at the second time instant. In an embodiment, the second time instant corresponds to at least the time instant at which the first human subject is discharged from the medical facility. In an alternate embodiment, the second time instant may correspond to time instant after the time interval at which the condition of the first human subject is to be determined. In an embodiment, during the time interval the one or more treatments are utilized to treat the stroke patient.

In an embodiment, the prediction unit 208 may be configured to predict the one or more second scores at the second time instant based on a training of the probabilistic model. After obtaining the estimates of the coefficients, the prediction unit 208 may be configured to predict the probability of the second score in accordance with equation 4. For the first human subject, the first score is available and the prediction unit 208 may be configured to compute the probability for all possible values of j (one or more second scores) and select the second score from the one or more second scores that has maximum probability from the one or more second scores. Thus, the prediction unit 208 may be configured to select the second score from the one or more second scores at the second time instant. In an embodiment, the second score may correspond to the outcome of the stroke event associated with the first human subject. In an embodiment, the second score may correspond to the highest value from the one or more second scores.

In an embodiment, maximum likelihood parameter estimation may be implemented using standard gradient ascent by the prediction unit 208. The log likelihood of the contingency matrix of the training data utilized for prediction may be determined in accordance with equation 5.

$$l ( θ ) = {\sum }_{i}^{K} {\sum }_{j}^{K} {\sum }_{k}^{N} {r}_{k , i} {c}_{k , j} [ {β}_{0 , i} + {\sum }_{l = 1}^{L} {β}_{l , i} {x}_{k , l} - log \{ exp ( {β}_{0 , i +} {\sum }_{l = 1}^{L} {β}_{l , i} {x}_{k , l} ) + {K}_{ij} exp ( {δ}_{0 j} - {\sum }_{m = 1}^{M} {δ}_{mj} {y}_{km} ) + α \} ] \qquad ( 5 )$$

In order to estimate the maximum likelihood of the parameters θ=(β_{0,i}, β_{l,i}, δ₀ⱼ, θₘⱼ), the prediction unit 208 may be configured to equate each of the partial derivatives as shown below to zero. In an embodiment, the partial derivatives may be computed as follows:

$$\frac{\partial l ( {θ}^{( t - 1 )} )}{\partial {β}_{0 i}} = {\sum }_{j = 1}^{K} {\sum }_{k = 1}^{N} {r}_{k , i} {c}_{k , j} [ 1 - \frac{exp ( {β}_{0 , i} + {\sum }_{l = 1}^{L} {β}_{l , i} {x}_{k , l} )}{\begin{matrix}exp ( {β}_{0 , i} + {\sum }_{l = 1}^{L} {β}_{l , i} {x}_{k , l} ) + \\ {K}_{ij} exp ( {δ}_{0 j} - {\sum }_{m = 1}^{M} {δ}_{mj} {y}_{km} ) + α\end{matrix}} ]$$

$$\frac{\partial l ( {θ}^{( t - 1 )} )}{\partial {β}_{li}} = {\sum }_{j = 1}^{K} {\sum }_{k = 1}^{N} {r}_{k , i} {c}_{k , j} {x}_{kl} [ 1 - \frac{exp ( {β}_{0 , i} + {\sum }_{l = 1}^{L} {β}_{l , i} {x}_{k , l} )}{\begin{matrix}exp ( {β}_{0 , i} + {\sum }_{l = 1}^{L} {β}_{l , i} {x}_{k , l} ) + \\ {K}_{ij} exp ( {δ}_{0 j} - {\sum }_{m = 1}^{M} {δ}_{mj} {y}_{km} ) + α\end{matrix}} ]$$

$$\frac{\partial l ( {θ}^{( t - 1 )} )}{\partial {γ}_{0 j}} = - {{\sum }_{j = 1}}^{K} {\sum }_{k = 1}^{N} {r}_{k , i} {c}_{k , j} [ \frac{{K}_{ij} exp ( {δ}_{0 j} + {\sum }_{m = 1}^{M} {δ}_{mj} {y}_{km} )}{\begin{matrix}exp ( {β}_{0 , i} + {\sum }_{l = 1}^{L} {β}_{l , i} {x}_{k , l} ) + \\ {K}_{ij} exp ( {δ}_{0 j} + {\sum }_{m = 1}^{M} {δ}_{mj} {y}_{km} ) + α\end{matrix}} ]$$

$$\frac{\partial l ( {θ}^{( t - 1 )} )}{\partial {γ}_{mj}} = - {{\sum }_{j = 1}}^{K} {\sum }_{k = 1}^{N} {r}_{k , i} {c}_{k , j} [ \frac{{y}_{km} {K}_{ij} exp ( {δ}_{0 j} + {\sum }_{m = 1}^{M} {δ}_{mj} {y}_{km} )}{\begin{matrix}exp ( {β}_{0 , i} + {\sum }_{l = 1}^{L} {β}_{l , i} {x}_{k , l} ) + \\ {K}_{ij} exp ( {δ}_{0 j} + {\sum }_{m = 1}^{M} {δ}_{mj} {y}_{km} ) + α\end{matrix}} ]$$

The partial derivatives computed by the prediction unit 208 do not form a closed solution. Thus, the gradient ascent method may be utilized to solve each of the parameters iteratively. In an embodiment, the recursion relation at the t^{th} iteration may be given in accordance with equation 6 below.

θ^{(t)}=θ^{(t-1)}+η∇l(θ^{(t-1)}) (6)

where

η is the step size; and

$$η ∇ l ( {θ}^{( t - 1 )} ) = ( \frac{\partial l ( {θ}^{( t - 1 )} )}{\partial {β}_{0 i}} , \frac{\partial l ( {θ}^{( t - 1 )} )}{\partial {β}_{li}} , \frac{\partial l ( {θ}^{( t - 1 )} )}{\partial {γ}_{0 j}} , \frac{\partial l ( {θ}^{( t - 1 )} )}{\partial {γ}_{mj}} )$$

In an embodiment, the iterations are continued until convergence to determine the maximum likelihood estimates.

Based on the maximum likelihood estimation, along with the prediction of the outcome of the stroke event associated with the first human subject, the application server 104 may be configured to identify at least one treatment from the one or more treatments based on the one or more second observations that have maximum impact on the prediction of the outcome of the stroke event associated with the first human subject. For this, instead of taking the columns as the second score j in the contingency matrix, the prediction unit 208 may be configured to determine a difference between the first score and the second score associated with the first human subject. In an embodiment, the “difference” refers to value obtained by performing a subtraction operation between the first score and the second score associated with the first human subject. In an embodiment, the difference is indicative of an improvement or deterioration in the first human subject's condition. In an embodiment, a positive value of the difference indicates improvement in the first human subject's condition, and a negative value of the difference indicates deterioration in the first human subject's condition. In an alternate embodiment, the contingency matrix may be modified to a modified contingency matrix. The modified contingency matrix may indicate the probability of change in the second score of a first human subject by J. In an embodiment, J corresponds to the difference. For example, for predicting at least one treatment from the one or more treatments that led to an improvement by ‘1’, the prediction unit 208 may select the treatment that has the smallest δₘ₁ value amongst the remaining δₘⱼ values associated with each of the one or more treatments. Thus, the treatment associated with the δₘ₁ value may be considered as the most influential treatment.

For example, let a subset of one or more second observations denoted by yₖ contain five treatments, such as “Aravon”, “Heparin”, “Fragmin”, “Calcium Channel Blocker”, and “Pantoprazole”. As described above, the modified contingency matrix is computed for the above listed one or more second observations. In an embodiment, in the modified contingency matrix, 0 denotes no improvement, −1 denotes deterioration and 1 denotes improvement. Further, the prediction unit 208 may be configured to determine the δ₁ values. An example of the δ₁ values may be shown as below:

δ_{1=(0.13, 0.09, 0.29, 0.32, 0.10)}

All the values are positive thus, in an embodiment, the values may be rescaled (by subtracting their mean and dividing it by their standard deviation) to obtain the relative importance. In an embodiment, the rescaled coefficients may be shown as below:

δ_{1=(-0.51, -0.87, 0.95, 1.21, -0.78)}

Based on the rescaled coefficients, “Aravon”, “Heparin”, and “Pantoprazole” have negative coefficient values, which indicate that these treatments have the most impact in the improvement of the first human subject's health condition. Further, in an embodiment, the application server 104, may be configured to statistically test the importance of each of the one or more treatments based on the distributions of each of the values.

A person skilled in the art will understand that the example of selecting the second score from the one or more second scores after the time interval at the second time instant based on the aforementioned factors has been provided for illustrative purposes and should not be construed to limit the scope of the disclosure.

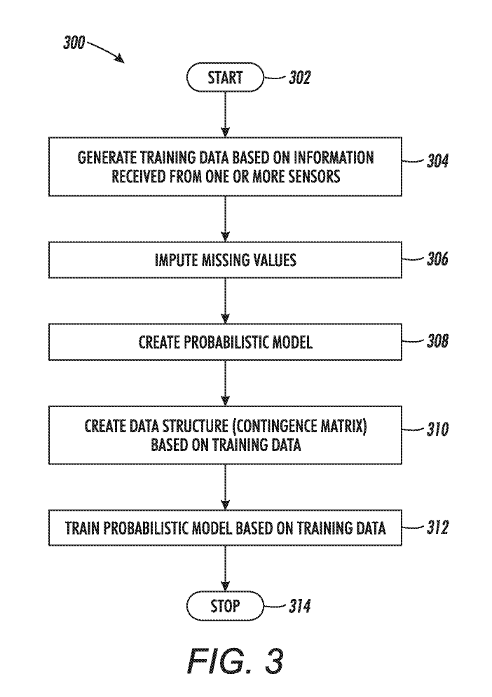

FIG. 3 illustrates a flowchart 300 of a method to create and train the probabilistic model, in accordance with at least one embodiment. The flowchart 300 is described in conjunction with FIG. 1 and FIG. 2. The method starts at step 302 and proceeds to step 304. In an embodiment, the database server 102 may be configured to generate the patient dataset associated with the plurality of second human subjects based on the one or more second observations obtained via the one or more sensors of the user-computing device 108. Further, the patient dataset may also store the first score, the second score, and the one or more first observations associated with the plurality of second human subjects. The generated patient dataset may be stored in the database server 102.

At step 304, the application server 104 may be configured to receive the training data (first score, second score, one or more first observations and one or more second observations) associated with the plurality of second human subjects from the database server 102. At step 306, the application server 104 may be configured to impute missing values in the one or more second observations associated with the plurality of second human subjects as described in FIG. 2. In an embodiment, after imputation of the missing values, the application server 104 may be configured to update the patient dataset based on the imputed values.

At step 308, the application server 104 may be configured to create the probabilistic model based on the first score, second score, the one or more first observations, and the one or more second observations associated with the plurality of second human subjects. The creation of the probabilistic model has been explained in detail in FIG. 2. At step 310, the application server 104 may be configured to create the k1×k2 dimensional data structure based on the training dataset. In an embodiment, each entry in the data structure may correspond to a number of the plurality of second human subjects having a first score k1 and a second score k2. In an embodiment, the k1×k2 dimensional data structure may correspond to the contingency matrix.

At step 312, the application server 104 may be configured to train the probabilistic model based on the training data of the plurality of second human subjects. In an embodiment, during the training phase of the probabilistic model, an N−1 training approach may be utilized. For example, if there are N instances in the patient dataset, then N−1 instances are used for training the probabilistic model and the Nth instance is used as the test instance. Such a training methodology may be implemented for each of the N instances to train the probabilistic model. After the training of the probabilistic model, control passes to end step 314.

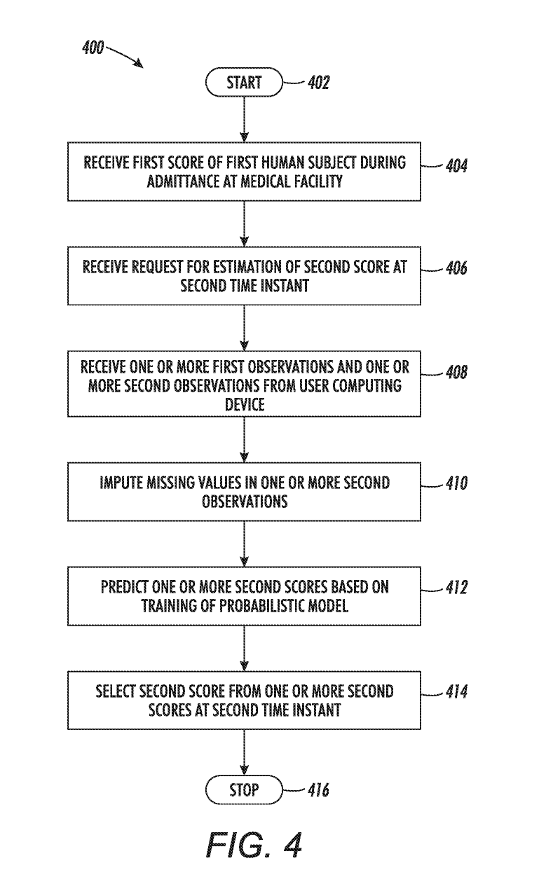

FIG. 4 illustrates a flowchart 400 of a method to utilize the trained probabilistic model to predict the outcome of a stroke event associated with the first human subject, in accordance with at least one embodiment. The flowchart 400 is described in conjunction with FIG. 1 and FIG. 2. The method starts at step 402 and proceeds to step 404.

At step 404, the application server 104 may receive the first score associated with the first human subject. In an embodiment, the first score may correspond to a Rankin score of the first human subject determined at the first time instant of admittance of the first human subject into the medical facility.

At step 406, the application server 104 may be configured to receive a request at the second time instant from the user-computing device 108 for estimation of the second score associated with the first human subject. Along with the request, at step 408, the application server 104 may be configured to receive the one or more first observations and the one or more second observations associated with the first human subject from the user-computing device 108. At step 410, the application server 104 may be configured to impute missing values in the one or more second observations associated with the first human subject. After imputation of the missing values, at step 412, the application server 104 may be configured to predict the one or more second scores at the second time instant based on the trained probabilistic model. At step 414, the application server 104 may be configured to select, at the second time instant, the second score from the one or more second scores. In an embodiment, the second score may correspond to the outcome of the stroke event associated with the first human subject. In an embodiment, the second score may correspond to the highest value of the second score from the one or more second scores. Control passes to end step 416.

FIG. 5 illustrates an example user-interface 500 presented on a user-computing device to display the predicted outcome (second score) of the stroke event associated with the first human subject. FIG. 5 is described in conjunction with FIG. 1 and FIG. 2.

With reference to FIG. 5, the user-interface 500 is displayed on the user-computing device 108. The block 502 corresponds to an input box that may be utilized by the user to provide an input corresponding to the first score of the first human subject. For example, the user interface element 502 may specify that the first score of the first human subject was ‘3’. Further, user interface (UI) elements are displayed on a display screen of the user-computing device 108 to obtain the one or more first observations and the one or more second observations associated with the first human subject. In an embodiment, the one or more first observations may be divided into four major categories. Examples of such categories may include demographic details, addiction, time, and preconditions associated with the first human subject. In an embodiment, the demographic details associated with the first human subject may be input by the user by utilizing the user interface elements 504, 506, and 508. The user interface elements 504, 506, and 508 may correspond to age, gender, and the religion of the first human subject, respectively. For example, the UI element 504 may indicate ‘26’ as the age of the first human subject. Similarly, the UI element 506 may indicate that the gender of the first human subject is ‘Male’. Similarly, the UI element 508 may indicate that the religion of the first human subject is ‘Christian’.

In an embodiment, the addictions associated with the first human subject may be input by the user by utilizing the user interface elements 510, 512, and 514. The user interface elements 510, 512, and 514 may correspond to smoking, alcohol, and betel nut, respectively. For example, the UI element 516 may indicate that the first human subject has a smoking addiction. Similarly, the UI element 512 and 514 may indicate that the first human subject has no addiction of alcohol and betel nut, respectively.

In an embodiment, the time details associated with the first human subject may be input by the user by utilizing the user interface elements 516, 518, and 520. The user interface elements 516, 518, and 520 may correspond to date of stroke event, date of start of treatment, and admission date of the first human subject, respectively. For example, the UI element 516 may be used by the user to input the date of the stroke event. Similarly, UI element 518 may be used by the user to input the date of the start of treatment. Similarly, UI element 520 may be used by the user to input the date of the admission of the first human subject at the medical facility.

In an embodiment, the preconditions associated with the first human subject may be input by the user by utilizing the user interface element 522. The user interface element 522 may indicate one or more preconditions associated with the first human subject. For example, the user may specify that the first human subject was suffering from slight fever at the second time instant.

Further, using the user interface element 524, the user may input values of the one or more second observations associated with the first human subject. After entering all the values in the said UI elements, the user may perform an input operation on the control button indicated by 526. In an embodiment, when the user performs an input operation, such as a click operation using a mouse, the user computing device may send the first score, the one or more first observations, and the one or more second observations to the application server 104. Further, the application server 104 may predict the outcome (second score) of the stroke event associated with the first human subject and transmit the second score to the user-computing device 108. The second score of the first human subject predicted at the second time instant may be displayed in the UI element 528. For example, the predicted second score of the first human subject is ‘2’. In an embodiment, the user-computing device 108 may also display at least one treatment that has maximum impact on the prediction of the second score. Such treatment and its associated details may be displayed in the UI element 530.

Various embodiments of the disclosure provide a non-transitory computer readable medium and/or storage medium, and/or a non-transitory machine-readable medium and/or storage medium having stored thereon, a machine code and/or a computer program having at least one code section executable by a machine and/or a computer to predict an outcome of a stroke event associated with a first human subject. The at least one code section in an application server 104 causes the machine and/or computer to perform the steps, which comprises receiving, by one or more processors, a first score, one or more first observations, and one or more second observations associated with a first human subject. In an embodiment, the first score and the one or more first observations are determined at a first time instant of admittance of the first human subject into a medical facility. In an embodiment, wherein the one or more second observations are received from one or more sensors during a time interval between the first time instant and a second time instant. Predicting, by the one or more processors, one or more second scores at the second time instant based on a training of a probabilistic model. Selecting, by the one or more processors, a second score from the one or more second scores at the second time instant, wherein the second score corresponds to an outcome of a stroke event associated with the first human subject, wherein the second score corresponds to the highest value from the one or more second scores.

Various embodiments of the disclosure encompass numerous advantages including method and system for predicting an outcome of a stroke event associated with a first human subject. Further, the method also helps in better treatment planning of the stroke patients by recommending a treatment that is most effective for improving the health condition of the stoke patient. In an embodiment, the disclosure also discloses a method for handling missing values in a patient dataset. The disclosed method predicts the outcome (second score) associated with the first human subject based on a given set of features (first score, one or more first observations and one or more second observations).

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it may be intended that the present disclosure not be limited to the particular embodiment disclosed, but that the present disclosure will include all embodiments falling within the scope of the appended claims.

What is claimed is:

1. A method for predicting an outcome of a stroke event associated with a first human subject, the method comprising:
in an application server:
receiving, by one or more processors, a first score, one or more first observations, and one or more second observations associated with the first human subject, wherein the first score and the one or more first observations are determined at a first time instant of admittance of the first human subject into a medical facility, and wherein the one or more second observations are received from one or more sensors during a time interval between the first time instant and a second time instant;
predicting, by the one or more processors, one or more second scores at the second time instant based on a training of a probabilistic model; and
selecting, by the one or more processors, a second score from the one or more second scores at the second time instant, wherein the second score corresponds to the outcome of the stroke event associated with the first human subject, wherein the second score corresponds to the highest value from the one or more second scores.

2. The method of claim 1, wherein a patient dataset of a plurality of second human subjects is generated that comprises a first score, one or more first observations, and one or more second observations associated with each of the plurality of second human subjects, wherein the first score and the one or more first observations are determined at the first time instant of admittance of the plurality of second human subjects into the medical facility, and wherein the one or more second observations are received from one or more sensors during the time interval between the first time instant and the second time instant.

3. The method of claim 2, wherein the probabilistic model is trained based on the patient dataset of the plurality of second human subjects.

4. The method of claim 1, wherein the second time instant corresponds to at least the time instant at which the first human subject is discharged from the medical facility.

5. The method of claim 1, further comprising creating, by the one or more processors, a k1×k2 dimensional data structure where each entry in the data structure corresponds to a number of the plurality of second human subjects having a first score k1 and a second score k2.

6. The method of claim 1, wherein during the time interval one or more treatments are utilized to treat the first human subject.

7. The method of claim 6, further comprising identifying, by the one or more processors, at least one treatment from the one or more treatments based on the one or more second observations that has maximum impact on the prediction of the outcome of the stroke event associated with the first human subject.

8. The method of claim 1, further comprising determining, by the one or more processors, a difference between the first score and the second score associated with the first human subject, wherein the difference is indicative of an improvement or deterioration in the first human subject's condition, wherein a positive value of the difference indicates improvement in the first human subject's condition, and wherein a negative value of the difference indicates deterioration in the first human subject's condition.

9. The method of claim 1, wherein the first score and the second score corresponds to a Rankin score.

10. The method of claim 1, wherein the one or more first observations comprises at least an age, a gender, and one or more preconditions.

11. The method of claim 1, wherein the one or more second observations comprises at least a radiology investigation, treatment details, clinical investigations, and physical examination results.

12. An application server for prediction of an outcome of a stroke event associated with a first human subject, the application server comprising:
one or more processors configured to:
receive a first score, one or more first observations, and one or more second observations associated with the first human subject, wherein the first score and the one or more first observations are determined at a first time instant of admittance of the first human subject into a medical facility, and wherein the one or more second observations are received from one or more sensors during a time interval between the first time instant and a second time instant;
predict one or more second scores at the second time instant based on a training of a probabilistic model; and
select a second score from the one or more second scores at the second time instant, wherein the second score corresponds to the outcome of the stroke event associated with the first human subject, wherein the second score corresponds to the highest value from the one or more second scores.

13. The application server of claim 12, wherein a patient dataset of a plurality of second human subjects is generated that comprises a first score, one or more first observations, and one or more second observations associated with each of the plurality of second human subjects, wherein the first score and the one or more first observations are determined at the first time instant of admittance of the plurality of second human subjects into the medical facility, and wherein the one or more second observations are received from one or more sensors during the time interval between the first time instant and the second time instant.

14. The application server of claim 12, further comprising imputing missing values in the one or more second observations based on a measure of association determined between each of the missing values and one or more second observations for which the values are known.

15. The application server of claim 12, wherein the probabilistic model is trained based on the patient dataset of the plurality of second human subjects.

16. The application server of claim 12, wherein the second time instant corresponds to at least the time instant at which the first human subject is discharged from the medical facility.

17. The application server of claim 12, wherein during the time interval one or more treatments are utilized to treat the first human subject.

18. The application server of claim 17, wherein the one or more processors are further configured to identify at least one treatment from the one or more treatments based on the one or more second observations that has maximum impact on the prediction of the outcome of the stroke event associated with the first human subject.

19. The application server of claim 12, wherein the one or more processors are further configured to determine a difference between the first score and the second score associated with the first human subject, wherein the difference is indicative of an improvement or deterioration in the first human subject's condition, wherein a positive value of the difference indicates improvement in the first human subject's condition, and wherein a negative value of the difference indicates deterioration in the first human subject's condition.

20. The application server of claim 12, wherein the first score and the second score corresponds to a Rankin score.

21. A non-transitory computer-readable storage medium having stored thereon, a set of computer-executable instructions for causing a computer comprising one or more processors to perform steps comprising:
receiving, by one or more processors, a first score, one or more first observations, and one or more second observations associated with a first human subject, wherein the first score and the one or more first observations are determined at a first time instant of admittance of the first human subject into a medical facility, and wherein the one or more second observations are received from one or more sensors during a time interval between the first time instant and a second time instant;
predicting, by the one or more processors, one or more second scores at the second time instant based on a training of a probabilistic model; and
selecting, by the one or more processors, a second score from the one or more second scores at the second time instant, wherein the second score corresponds to an outcome of a stroke event associated with the first human subject, wherein the second score corresponds to the highest value from the one or more second scores.
